(19) United States
(12) Patent Application Publication
(10) Pub. No.: US 2003/0233584 A1
(43) Pub. Date: Dec. 18, 2003

(54) Method and system using combinable computational puzzles as challenges to network entities for identity check

(75) Inventor: John R. Douceur, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/171,902

(22) Filed: Jun. 14, 2002

(51) Int. Cl. H04L 9/32

(52) U.S. Cl. 713/202; 713/169; 713/181

(57) ABSTRACT

Combinable computational puzzles are used as a challenge mechanism for a computer to challenge network entities to determine whether the ostensibly separate network entities are in fact distinct computers. The combinable computational puzzles are constructed such that multiple puzzles can be combined into a single puzzle, which can be solved with approximately the same effort as that required to solve each of the individual original puzzles, and solutions to the individual original puzzles can be derived easily from the solution to the combined puzzle. A computer that is challenged by multiple computers with separate combinable puzzles at the same time is able to respond to the challenges by combining the puzzles into one combined puzzle that it is able to solve in a allotted time period. On the other hand, a challenging computer is able to determine that two or more of the combinable puzzles it sent to ostensibly separate network entities have been combined and solved together, which is an indication that the network entities are in fact presented by one corrupt computer.

### TECHNICAL FIELD

This invention relates generally to security issues in a computer network, and more particularly to a way to check whether entities in a network that claim to be distinct are in fact distinct computers.

### BACKGROUND OF THE INVENTION

As computer networking becomes prevalent, various peer-to-peer network systems are being developed for various tasks such as file sharing, distributed processing and storage. A peer-to-peer network comprises a plurality of computers networked together such that they can talk directly to each other rather than through a server. These peer computers, which present themselves as network entities on the network, share their resources, including their processing power and/or storage space, with the other computers in the peer-to-peer network.

As with most computer networks, security is an important topic for peer-to-peer network systems. One particular security issue for a peer-to-peer network system is that some computers in the peer-to-peer system may be faulty (i.e., corrupt, hostile, or otherwise unreliable) and thus cannot be trusted. Since a computer in a peer-to-peer network relies upon other machines in the network for data processing and storage, the existence of corrupt computers in the network can significantly undermine the viability of the peer-to-peer computing model. To mitigate and resist the threat of faulty machines in the network, peer-to-peer systems often rely on redundancy sending the same processing task or data inquiry request to two or more peer entities (each of which is supposed to be a distinct computer) at the same time. If the peer entities provide different results, then at least one of them is likely to be faulty. Thus, redundancy provides a measure for a requesting computer to identify potentially unreliable entities in the peer-to-peer network.

One problem with the redundancy approach is that a corrupt computer can often defeat that security mechanism by presenting itself as multiple peer entities on the network. Thus, if the requesting computer sends its request to those peer entities presented by the corrupt computer, it will get the same wrong result back from those peer entities and will not be able to tell that the result is invalid. Because a computer is allowed to have multiple network addresses, it is difficult for a requesting computer to tell whether the remote peer entities it is dealing with are in fact distinct individual computers or just virtual devices presented by a single corrupt computer.

To combat this problem, it has been proposed to use computational puzzles as a challenge mechanism by which a computer can test whether the peer entities it wants to talk to are really distinct devices. Computational puzzles are computational problems that one computer can give to another computer as a challenge, i.e., asking the challenged computer to solve within a given amount of time. The puzzles are designed to require a challenged computer to perform a significant amount of computational work to solve one puzzle but require very little computational effort for the challenging computer to verify the solution returned by the challenged computer. In the context of a peer-to-peer system, a computer that wants to verify the identities of its peer entities can challenge several peer entities by sending out different computational puzzles, one to each of the peer entities, at the same time and asking them to solve the puzzles within a given time period. The puzzles are set up such that the resources of a single computer are likely to be insufficient to solve more than one puzzle in the allotted time. Thus, if a corrupt computer presents itself as two (or more) peer entities and both peer entities are challenged at the same time, it will receive two computational puzzles and is likely unable to solve both puzzles in time. The failure of the peer entities to solve the puzzles in time is an indication that they are faulty, and the challenging computer can avoid further dealing with them.

As described above, the efficacy of the challenge mechanism based on computational puzzles is premised on the assumption that a single challenged computer, which may have presented itself as two or more peer entities, is not able to solve more than one puzzle at one time. This assumption, however, presents a dilemma. It is possible that multiple computers in the peer-to-peer system may challenge a single computer at the same time with separate computational puzzles. Since it is presumed that the resources of the challenged computer is not sufficient for solving more than one puzzle at a time, the challenged computer will fail to respond to all but one of the challenges and will be considered by some of the challenging computers to be faulty even if it is not.

### SUMMARY OF THE INVENTION

In view of the foregoing, the present invention provides a solution to the dilemma identified above, thereby making it feasible to use computational puzzles as challenges to network entities, such as peer entities in a peer-to-peer system, to determine whether ostensibly different network entities are in fact distinct computers. In accordance with the invention, computational puzzles of a new type called “combinable computational puzzles” are used by a computer to challenge network entities. Combinable computational puzzles are computational puzzles constructed such that multiple puzzles can be combined into one single puzzle, and solving that combined puzzle provides simultaneously the solutions to the original puzzles. When a computer is challenged by other computers with multiple separate combinable puzzles at the same time, it can combine the puzzles into one puzzle, which it is able to solve in the allotted time period under the constraints of its resources. Thus, the use of combinable computational puzzles enables a computer to respond to multiple challenges from different computers at the same time, even though its resources would only allow it to solve one puzzle within the given time period.

In accordance with a related aspect of the invention, the combinable computational puzzles are constructed such that it can be determined whether two (or more) separate puzzles have been solved together (i.e., combined into one puzzle) or separately. This allows a challenging computer to detect a corrupt computer that presents itself to be multiple network entities, if the multiple entities are simultaneously challenged by the challenging computer and the corrupt computer attempts to solve the puzzles given to the multiple entities by combining them together. When the challenging computer detects that the puzzles have been solved together, it knows that the challenged network entities are not in fact distinct machines but rather are presented by a corrupt computer.

In accordance with another aspect of the invention, a challenge to a peer entity may comprise a plurality of small puzzles rather than a single large puzzle. The challenged entity is required to solve the small puzzles separately. In other words, the challenged entity is not allowed to combine the small puzzles into a single combined puzzle and solve the combined puzzle. The variance in the actual time the challenged entity spends on solving all of the small puzzles is reduced as compared to the variance in the time required to solve a single large puzzle. This reduction in the variance of the actual processing time makes it less likely for a corrupt computer to be able to handle two different challenges at the same time, thereby enhancing the effectiveness of the challenge mechanism based on computational puzzles.

### BRIEF DESCRIPTION OF THE DRAWINGS

FIG. 1 is a block diagram generally illustrating an exemplary computer system on which the present invention may be implemented;

FIG. 2 is a schematic diagram showing multiple combinable computational puzzles that are combined into a single combined puzzle, and the derivation of the solutions to the individual puzzles from the solution to the combined puzzle; and

FIG. 3 is a schematic diagram showing a peer-to-peer network in which computers challenge other peer entities with combinable computational puzzles for detecting whether the peer entities correspond to distinct computers.

### DETAIL DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

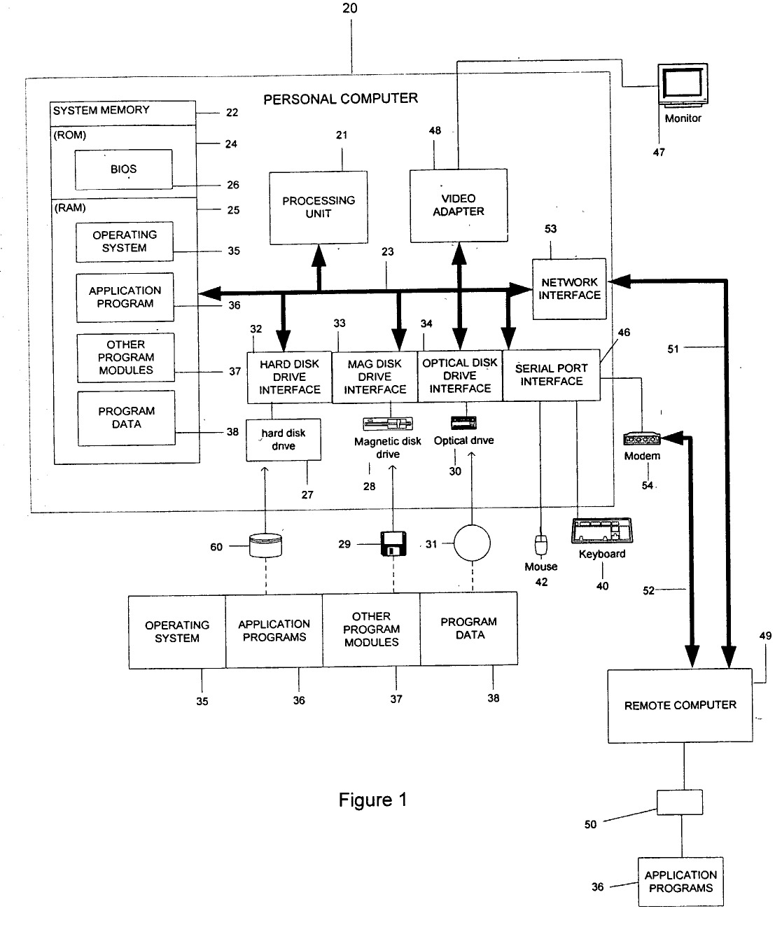

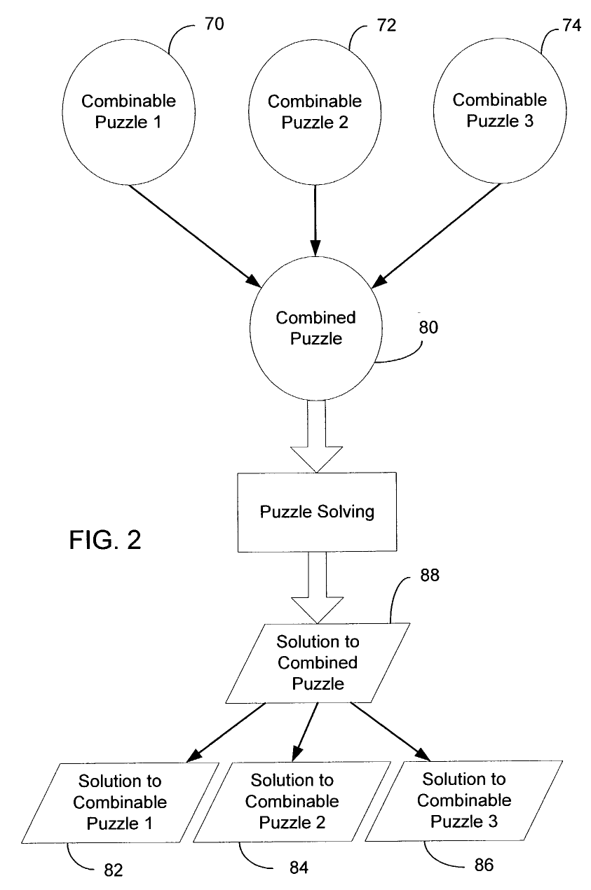

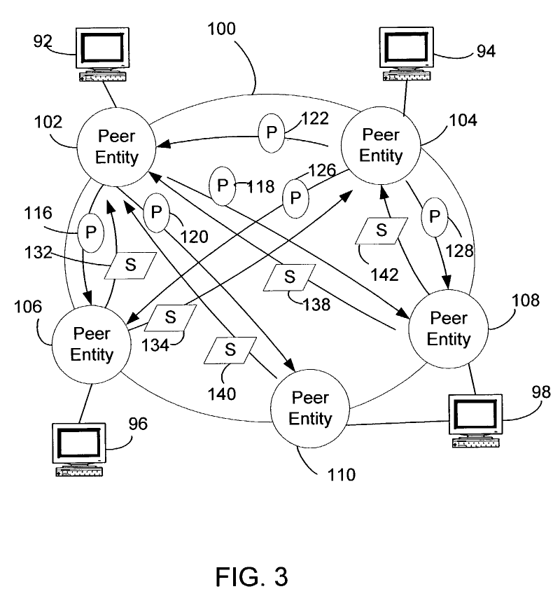

The following description begins with a description of a general-purpose computing device that may be used in an exemplary system for implementing the invention, and the invention will be described in greater detail with reference to FIGS. 2 and 3. Turning now to FIG. 1, a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

Referring now to FIG. 2, the present invention is directed to the use of a new class of computational puzzles as challenges that are given to network entities to determine whether those network entities correspond to distinct computers. For instance, in one embodiment as described below, a challenging computer in a peer-to-peer network can use the combinable computational puzzles to challenge its peer entities in the network. In accordance with the invention, the computational puzzles are “combinable” in the sense that a plurality of separate computational puzzles can be combined into a single computational puzzle, and the solution to the combined puzzle provides simultaneously the solutions to the original puzzles used to form the combined puzzle. As used herein, the phrase “providing simultaneously” is intended to mean that once the combined puzzle is solved, the solution to each of the original puzzle can be derived readily and quickly from the solution to the combined puzzle without the need for extensive computation.

By way of example, FIG. 2 shows three combinable computational puzzles 70, 72, and 74. These computational puzzles may be, for example, puzzles received by a computer as challenges from other computers in a peer-to-peer network. Because the puzzles are combinable, the challenged computer can combine the three puzzles into one “combined” puzzle 80. Thus, instead of solving the three separate puzzles 70, 72, and 74, the challenged computer only has to solve a single combined puzzle 80. After challenged computer has solved the combined computational puzzle 80, the solutions 82, 84 and 86 to the individual original computational puzzles 70, 72, and 74, respectively, are derived from the solution 88 to the combined puzzle.

The combinable computational puzzles are preferably designed such that the resources required to solve the combined puzzle are not significantly greater than those required for solving each of the original puzzles used to form the combined puzzle. In other words, preferably the challenged computer can solve the combined puzzle in substantially the same amount of time it is expected to spend on solving each of the original individual puzzles. Also, as mentioned above, the combinable puzzles are designed such that the solutions to the combinable puzzle can be derived readily and easily, without extensive computational efforts, from the solution to the combined puzzle. As will become clear from the description below, such characteristics of the combinable puzzles contribute to the efficacy of a challenge mechanism based on combinable computational puzzles.

One specific example of a combinable computational puzzle is now described. This type of combinable computational puzzle is based on cryptographically secure hash functions. Unlike any conventional computational puzzles, this type of puzzle has the special property of being combinable, i.e., a plurality of puzzles can be combined into a single puzzle. To construct a puzzle, a challenging computer generates a large random value y. The size of this value may be, for example, 128 bytes in length. The task for the challenged computer is to find a pair of values x and z such that the concatenation x|y|z, when run through a cryptographically secure hash function, yields a value whose least significant n bits are all zero. Formally, this puzzle is presented as:

given y, find x, z such that LSBₙ(hash(x|y|z))=0 (Equation 1)

The mean time for solving such a puzzle is proportional to 2ⁿ⁻¹, because the only known way for a challenged computer to find a solution (assuming that the hash function is truly secure) is to iterate through candidate values of x and/or z, compute the hash for each xlylz triple, and test the hash value to see whether the least significant n bits are zero.

In accordance with the invention, a plurality of computational puzzles of the formulation defined in Equation 1 can be combined into a single puzzle. The combined puzzle in this case can be solved with approximately the same effort as that required to solve each of the individual original puzzles that are combined into the combined puzzle. If an entity being challenged receives m puzzles y₁, y₂, . . . , yₘ, it can concatenate them and solve the concatenation as a single puzzle. In particular, the challenged entity can find a number w such that:

LSBₙ(hash(0|y₁|y₂| . . . |yₘ|w))=0 (Equation 2)

It will be appreciated that the time required to solve this combined puzzle is similar to the time required to solve each of the original puzzles. Given all of the yᵢ values, the challenged machine can pre-compute a partial hash of 0|y₁|y₂| . . . |yₘ, save the state of this hash computation, and then try many different w values in succession, starting the hash computation for each w value with the saved partial hash state. This makes the computation of the hash value for each w value tried independent of the number of the yᵢ values.

Once a value of w that satisfies the condition in Equation 2 is found, the solution to each original puzzle yₖ is the pair xₖ and zₖ defined as follows:

xₖ=0|y₁|y₂| . . . yₖ₋₋₁ (Equation 3)

zₖ=yₖ₊₁| . . . yₘ|w (Equation 4)

Thus, the solutions to the original puzzles can be readily derived from the solution to the combined puzzle.

In accordance with a related aspect of the invention, the combinable puzzles are designed such that a challenging computer can determine whether two or more combinable puzzles it issued to ostensibly distinct network entities have been solved together (i.e., as a combined puzzle) or separately. The combinable puzzles in the form defined in Equation 1 have this property, and it is easy for the challenging computer to make the determination. For instance, for any two puzzles y₁, y₂ issued to two supposedly distinct entities, the challenging computer can check the solutions x₁, z₁ and x₂, z₂ returned by the challenged entities. If x₁|y₁|z₁=x₂|y₂|z₂, then it is with near certainty that the two puzzles have been solved together as parts of a combined puzzle. This is an indication that the two challenged entities to which the puzzles were sent are actually the same computer, which attempted to solve the puzzles in the allotted time by combining the two puzzles (possibly with other puzzles received from other challenging computers) and solving the combined puzzle. Thus, by checking the solutions to the issued puzzles returned by the challenged entities, a challenging computer can detect whether its puzzles were impermissibly combined into a single puzzle and solved by a corrupt computer that presents itself as multiple peer entities.

To illustrate by way of example how the combinable computational puzzles can be used as a challenge mechanism for checking the identities of network entities, FIG. 3 shows a plurality of computers 92, 94, 96, and 98 in a peer-to-peer network 100. For simplicity of illustration, only a small number of computers are shown. In this example, each of the computers 92, 94, and 96 presents itself as a single network entity. Thus, they correspond to the network entities 102, 104 and 106. The computer 98, however, is corrupt and presents itself as two peer entities 108 and 110 on the network 100. To detect such fraudulent presentation, the computer 92 sends combinable computational puzzles 116, 118, and 120 as challenges to the peer entities 106, 108 and 110, respectively. At the same time, another computer 94 also sends out combinable computational puzzles 122, 126, 128 to the peer entities 102, 106, and 108, respectively. Thus, in this example, the computer 96 has received two puzzles 116 and 126 that it has to solve in the allotted time. If the puzzles were conventional computational puzzles, the computer 96 is expected to fail to respond to at least one of the challenges because it does not have sufficient resources to solve both puzzles in the given time.

With the combinable computational puzzles in accordance with the invention, however, the computer 96 is able to combine the two puzzles in to a single puzzle, solve the combined puzzle, and then derive the solutions to the original puzzles from the solution to the combined puzzle within the given time. After solving the puzzles, the computer returns the solutions 132 and 134 to the challenging entities 102 and 104, respectively, from which it received the puzzles. Because the network entity 106 is able to solve the puzzles in the given time, the challenging computers believe that the network entity corresponds to a single computer.

One the other hand, the corrupt computer 98 that presents itself as network entities 108 and 110 has received two puzzles 118 and 120 that are sent by the challenging computer 92 to the two network entities, as well as a puzzle 128 from the challenging computer 94. In order to solve the puzzles in time, the computer 98 solves them together by combining the three puzzles, solving the combined puzzle, and deriving the solutions for the original puzzles from the solution to the combined puzzle. The corrupt computer then returns the solutions 138 and 140 to the puzzles 118 and 120 through the two entities 108 and 110 to the entity 102, and the solution 142 to the puzzle 128 to the entity 104. As described above, however, the challenging computer 92 is able to detect that the two puzzles 118 and 120 have been solved together by checking the solutions to these puzzles. Thus, the challenging computer 92 is able to tell that the two entities 108 and 110 are in fact presented by a corrupt computer. The challenging computer can then avoid further interaction with the two entities and can request system administration to look into the detected fraudulent presentation.

In the examples described above, for simplicity of illustration and clarity of description, each challenge issued to a peer entity includes one combinable computational puzzle. There is, however, no requirement that each challenge can contain only a single puzzle. In accordance with another aspect of the invention, a challenge to a network entity may comprise a plurality of small puzzles rather than a single large puzzle. The small puzzles are constructed such that the challenged computer is expected to have just enough resources to solve all the small puzzles within the allotted time for responding to the challenge. In this regard, it should be noted that the challenged entity is required to solve the small puzzles separately. In other words, the challenged entity is not allowed to combine the small puzzles into a single combined puzzle and solve the combined puzzle.

One potential advantage of using a plurality of small puzzles rather than a large puzzle as a challenge is the reduction of the variance of the amount of time the challenged computer will actually spend on responding to the challenge. For instance, the “size” of a puzzle of the formulation in Equation 1 is determined by the number n of the least significant bits of the hash that have to be zero. The mean time for a challenged computer to solve such a puzzle is proportional to 2ⁿ⁻¹. Thus, for example, instead of issuing a challenge containing one puzzle with n=15, the challenging computer can issue a challenge containing 8 smaller puzzles each having n=12. The mean time for solving the 8 small puzzles is substantially the same as the mean time for solving the single large puzzle.

The variance in the actual amount of time the challenged computer will spend on finding the solutions to the smaller puzzles is, however, significantly smaller than the variance for solving the single large puzzle in this example. The actual time for a challenged computer to find a solution to a single puzzle of the formulation of Equation 1 is governed by an exponential probability density function. An exponential distribution has a relatively large variance that is equal to the square of the mean value of the distribution. Thus, even if the size of the puzzle is set with the expectation that a challenged computer is able to solve only one such puzzle in the given challenge response time, a corrupt computer that has received two puzzles at the same time may actually succeed in solving both puzzles (separately) in time due to the large variance. In contrast, if the challenging computer issues a challenge that contains a number r of small puzzles, the time to find solutions to all puzzles separately is governed by an r-stage Erlangian probability density function. This attenuates the variance in the actual time for responding to the challenge by a factor of 1/r. This reduction in the variance of required processing time may be useful for enhancing the effectiveness of the challenge mechanism based on computational puzzles.

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

What is claimed is:

1. A computer-readable medium having computer-executable instructions for a computer to perform steps for challenging network entities for identity check, comprising:
generating a plurality of computational puzzles, the computational puzzles having a form allowing two or more of the computational puzzles to be solved together by combining the two or more computational puzzles into a single combined puzzle, solving the combined puzzle, and deriving solutions to the two or more computational puzzles from a solution to the combined puzzle;
issuing challenges to the network entities, each challenge including at least one of the computational puzzles and requiring a response in a given response time;
receiving solutions to the computational puzzles included in the challenges from the respective network entities to which the challenges are issued; and
determining from the solutions received whether two or more of the computational puzzles included in the challenges given to the network entities have been solved together.

2. A computer-readable medium as in claim 1, wherein the each challenge includes multiple computational puzzles to be solved separately by a network entity to which said each challenge is issued.

3. A computer-readable medium as in claim 1, wherein the computational puzzles are based on a cryptographic hash function.

4. A computer-readable medium as in claim 3, wherein each computational puzzle includes a given random number and requires the network entity to which the computational puzzle is given to find a solution that includes first and second numbers such that a hash value of a concatenated number of the first number, the given random number, and the second number has a pre-selected number of least significant bits equal to zero.

5. A computer-readable medium as in claim 1, wherein the computer is in a peer-to-peer network, and the network entities are peer entities of the computer.

6. A method for a computer to challenge network entities for identity check, comprising:
generating a plurality of computational puzzles, the computational puzzles having a form allowing two or more of the computational puzzles to be solved together by combining the two or more computational puzzles into a single combined puzzle, solving the combined puzzle, and deriving solutions to the two or more computational puzzles from a solution to the combined puzzle;
issuing challenges to the network entities, each challenge including at least one of the computational puzzles and requiring a response in a given response time;
receiving solutions to the computational puzzles included in the challenges from the respective network entities to which the challenges are issued; and
determining from the solutions received whether two or more of the computational puzzles included in the challenges given to the network entities have been solved together.

7. A method as in claim 6, wherein the step of issuing includes presenting in each challenge multiple computational puzzles to be solved separately by a network entity to which said each challenge is issued.

8. A method as in claim 6, wherein the computational puzzles are based on a cryptographic hash function.

9. A method as in claim 8, wherein each computational puzzle includes a given random number and requires the network entity to which the computational puzzle is given to find a solution that includes first and second numbers such that a hash value of a concatenated number of the first number, the given random number, and the second number has a pre-selected number of least significant bits equal to zero.

10. A method as in claim 6, wherein the computer is in a peer-to-peer network, and the network entities are peer entities of the computer.

11. A computer-readable medium having computer-executable instructions for a computer in a network to perform steps for responding to challenges issued by other computers in the network, comprising:
receiving a plurality of challenges from the other computers in the network, each of the challenges including at least one combinable computational puzzle;
combining the combinable computational puzzles in the challenges into a combined puzzle;
finding a solution to the combined puzzle;
deriving solutions to the combinational computational puzzles in the challenges from the solution to the combined puzzle; and
sending the solutions to the combinable computational puzzles to the respective computers from which the corresponding challenges are received.

12. A computer-readable medium as in claim 11, wherein each challenge includes multiple computational puzzles to be solved separately by the computer.

13. A computer-readable medium as in claim 11, wherein the computational puzzles are based on a cryptographic hash function.

14. A computer-readable medium as in claim 13, wherein each computational puzzle includes a given random number and requires the computer to find a solution that includes a set of first and second numbers such that a hash value of a concatenated number of the first number, the given random number, and the second number has a pre-selected number of least significant bits equal to zero.

15. A computer-readable medium as in claim 14, wherein the step of combining the computational puzzles includes concatenating the random numbers of the computational puzzles into a combined number, and the step of finding the solution to the combined puzzle includes finding a solution number such that a hash value of a concatenation of the combined number and the solution number has the pre-selected number of least significant bits equal to zero.

16. A computer-readable medium as in claim 15, wherein the step of finding the solution to the combined puzzle includes calculating a partial hash of the combined number and using the partial hash in hash calculations for finding the solution number.

17. A computer-readable medium as in claim 11, wherein the computer is in a peer-to-peer network, and the network entities are peer entities of the computer.

18. A method for a computer in a network to respond to challenges issued by other computers in the network, comprising:
receiving a plurality of challenges from the other computers in the network, each of the challenges including at least one combinable computational puzzle;
combining the combinable computational puzzles in the challenges into a combined puzzle;
finding a solution to the combined puzzle;
deriving solutions to the combinational computational puzzles in the challenges from the solution to the combined puzzle; and
sending the solutions to the combinable computational puzzles to the respective computers from which the corresponding challenges are received.

19. A method as in claim 18, wherein each challenge includes multiple computational puzzles to be solved separately by the computer.

20. A method as in claim 18, wherein the computational puzzles are based on a cryptographic hash function.

21. A method as in claim 20, wherein each computational puzzle includes a given random number and requires the computer to find a solution that includes a set of first and second numbers such that a hash value of a concatenated number of the first number, the given random number, and the second number has a pre-selected number of least significant bits equal to zero.

22. A method as in claim 21, wherein the step of combining the computational puzzles includes concatenating the random numbers of the computational puzzles into a combined number, and the step of finding the solution to the combined puzzle includes finding a solution number such that a hash value of a concatenation of the combined number and the solution number has the pre-selected number of least significant bits equal to zero.

23. A computer-readable medium as in claim 22, wherein the step of finding the solution to the combined puzzle includes calculating a partial hash of the concatenation of the combined number and using the partial hash in hash calculations for finding the solution number.

24. A method as in claim 18, wherein the computer is in a peer-to-peer network, and the network entities are peer entities of the computer.

25. A method of challenging peer entities in a peer-to-peer network, comprising:
generating a plurality of puzzles each represented by a random number;
sending separate challenges to be responded in a given response time to each of the peer entities, each challenge giving at least one puzzle to said each peer entity and requiring the peer entity to find a solution to the at least one puzzle, the solution to the at least one puzzle including a set of first and second numbers such that a hash value of a concatenated number of the first number, the random number of the at least one puzzle, and the second number has a pre-selected number of least significant bits equal to zero.

26. A method as in claim 25, further including the steps of:
receiving solutions to the puzzles given to the network entities; and
determining whether two or more of the puzzles have been solved together by concatenating the random numbers of the two or more puzzles.
